(19) United States
(12) Patent Application Publication
(10) Pub. No.: US 2007/0067643 A1
(43) Pub. Date: Mar. 22, 2007

(54) System and method for software tamper detection

(75) Inventors: Oscar V. Zhuk, Bellevue, WA (US); Glenn A. Morten, Bellevue, WA (US); James E. Veres, Woodinville, WA (US)

Correspondence Address: DARBY & DARBY P.C., P. O. BOX 5257, NEW YORK, NY, 10150-5257, US

(73) Assignee: Widevine Technologies, Inc., Seattle, WA (US)

(21) Appl. No.: 11/232,471

(22) Filed: Sep. 21, 2005

(51) Int. Cl. G06F 12/14

(52) U.S. Cl. 713/187

(57) ABSTRACT

A method, system, and apparatus are directed towards detecting unauthorized modification of software, such as virtual smart card software. An analysis is performed on the software to generate a unique pattern that is based on the integrity of the software. The pattern is generated using various portions of the software code. In one embodiment, matrix manipulations that involve a sequence of randomly selected matrix operations are performed on extracted portions of the software code. Sample sizes of the software code, sizes of the matrices, and other initialization parameters may be selected based on a desired security level. The resulting pattern may then be compared to a known normal pattern for the software to detect unauthorized modification. In one embodiment, however, the resulting pattern may be algorithmically combined with another value. The resulting combination may be used to decrypt content, if the software has not been modified.

### FIELD OF THE INVENTION

The invention relates generally to computing security, and more particularly but not exclusively to providing a system and method for detecting modification of software, such as Virtual Smart Card (VSC) software.

### BACKGROUND OF THE INVENTION

Connections to businesses, to the home, and to mobile devices have grown to the point where it is straightforward to deliver multimedia content to consumers. TV and movies are routinely delivered to homes over Cable TV (CATV) wires and are now they are beginning to be delivered to homes over Phone wires (POTS) and Fiber Optic connections. The proliferation of low-cost networking equipment and the highly wired nature of many homes today is leading to multimedia content being delivered over Internet Protocol (IP) networks. This new form of TV delivery over IP networks is called IPTV. The stream of content that may be delivered is typically split into packets. The packets may then be sent across the network to a receiving device (usually a Set Top Box (STB)) where the packets are decoded back into the stream.

Some companies have developed technology to prevent the unauthorized viewing of audio/video content (usually TV show, Pay-Per-View events (PPV), or Movies). One such approach accomplishes this protection by encrypting the content in the packets before it is sent over a network. Unauthorized reception of the packets doesn't usually allow theft of the content at least as long as the employed encryption method used is such that no reasonable means is available to decrypt the packets without the user knowing the decryption keys, or investing considerable time and money to ‘hack’ the encrypted packets.

However, one way that someone could steal content (for example, by viewing the content without having the rights to do so) would be for them to modify software running in a receiving device (usually a Set Top Box) such that a stream of packets could be intercepted after they had been decrypted. One such software application that a hacker might attempt to modify includes VSC software. Such virtual smart cards use software to implement content security to securely manage packet content. Unfortunately virtually all software systems including the virtual smart card software can be vulnerable to software modification (tampering). These modifications could result in improper functioning of the virtual smart card, or other software applications, and lead to unauthorized access to or copying of the decrypted content. Therefore, it is with respect to these considerations, and others, that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 shows one embodiment of a client device that may be included in a system implementing the invention;

FIG. 4 illustrates a logical flow diagram generally showing one embodiment of an overview process for detecting unauthorized modifications of software using a checking modification program (CMP);

FIG. 5 illustrates a logical flow diagram generally showing one embodiment of a process for preparing for a pattern creation by generating a Data Preparation Set (DPS) for use with the CMP;

FIG. 6 illustrates a logical flow diagram generally showing one embodiment of a process for performing the CMP to generate a pattern based, in part, on an integrity of software being evaluated;

FIG. 7 illustrates a logical flow diagram generally showing one embodiment of a process at a client device for a pattern creation based on the software being evaluated to determine a modification; and

FIG. 8 illustrates a logical flow diagram generally showing one embodiment of a process for generating a fingerprint usable in performing the CMP, in accordance with the invention.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Nor does the phrase “in another embodiment” necessarily refer to a different embodiment, although it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the invention is directed towards a system, apparatus, and method for detecting modification of software on a client device. In one embodiment, the software being evaluated is VSC software used to manage content protection. However, the invention is not so limited, and virtually any software may be evaluated by the invention.

The software to be evaluated may be stored in memory. In one embodiment, the software resides in memory on a client device, and a copy of the software, assumed to be unmodified, resides on a server device. A checking program, herein called the Checking Modification Program (CMP), is used to perform an initial analysis of the various memory locations containing the software on the server device. The memory locations analyzed may include all locations of the code or selected memory locations either contiguous or noncontiguous. The locations analyzed may also include locations where data values are stored that may include expected values known to the server device. The checking program may perform various operations on values obtained from memory to create a pattern based on the values retrieved from memory. The operations performed are chosen such that it would be virtually impossible for a hacker to make changes to the software and keep the pattern the same.

At various times an analysis of some or all of the memory locations containing the software and/or data values on the client device may be performed. These values may then be compared with the originally obtained values from the server device to determine if modification has taken place. In one embodiment, the checking program may be reconfigured to perform different checks on the software to make it harder for a hacker to hack the system. Such reconfigurations may be downloaded to the client device at various times. Downloading the reconfigurations of the checking programs to check the system's integrity could be done as often as several times per hour (or more often, as technology improves) making it more difficult to hack the system.

In one embodiment, of the invention, determining the integrity of the software application of interest may be performed within the client device. That is, the checking program may create a pattern based on the integrity of the software residing in memory on the client device. The pattern may then be analyzed by a component of the checking program, a decision engine, or another program. If the results of the analysis indicate modification of the software, various actions may be taken to protect the content, including sending messages to a content provider indicating modification, preventing receipt of the content by the client device, inhibiting decryption of the content, and/or otherwise performing actions directed to rendering access to the content, and/or the software program, futile.

In another embodiment of the invention, a server device may be employed to detect modification of the software of interest. Thus, in this embodiment, the server device may download the checking program onto the client device. The results of the checking program may then be sent to another program, a decision engine, or the like, residing on the server device. The results may be securely returned to the server device. The server device may then determine, based on the results, whether to continue sending content to the client or to stop sending content to the client, or even to perform other actions. This approach is directed to minimizing access to the checking program and thereby access to information regarding what a correct response might be. Moreover, because the server device could download various checking programs several times per hour the hacker may be further restricted.

Typical content protection systems may transmit in a secure manner decryption keys to a client device for use in decrypting content. These decryption keys can be rotated periodically (or a periodically) (up to several times per second) to ensure that a hacked key doesn't provide access to content for very long. Therefore, in one embodiment of the invention, the server device may elect to send values that when algorithmically combined with results of the checking program result in a decryption key that is employed to decrypt the content. The decryption key may be based on an algorithmic combination of several parts. A first part may, for example, be a content decryption key, a hash value, a checksum, or the like. The second part includes a value that is based on the integrity of the software in question, such as described below using the CMP, checksum, or the like.

Such algorithmic combinations may employ a variety of approaches, including exclusive or'ing (XOR) of the several parts, performing a series of rotates, XORs, adds, subtracts, or the like. However, such combinations are selected such that an inverse set of operations may also be performed. In one embodiment, such inverse set of operations are expected to be performable on a server device, and/or a client device, within a reasonable time period, such as less than minutes, or the like.

Moreover, to make a hacker's life more difficult, the algorithm used to combine the parts, may be changed every time a new key is employed. In one embodiment, this may be several times per minute. The algorithm may also be encrypted and sent to the client device. The server device and client device may also agree a priori on a sequence of algorithms to employ, select a next algorithm based on bits in a current decryption key, modify the algorithm based on bits in the current decryption key, or any of a variety of other approaches that may make it more difficult to reverse engineer the algorithm. In any event, by employing the algorithmic combination, a decryption key based on the integrity of the software may be generated that is unique and effect in that the client (or hacker) may never ‘know’ what result the checker program might generate.

In some environments, content may be either broadcast (sent to many clients) or unicast (sent to an individual client). Content that is broadcasted may be encrypted such that all clients viewing the content use the same decryption key to decrypt the content. Content that is typically only viewed by one client can be encrypted such that only that client has the key needed to decrypt the content. On-demand movies or client specific account information are examples where single clients receive the content.

Where only one client may receive the content, the checking modification program may include unique numbers that were generated by the software code when the client was provisioned in the generation of the unique numbers. This is directed towards creating a number that is unique for each instance of a STB. The results generated can be used as described above to self-check the integrity of the software, send the results back to a server where the integrity of the software code is determined, be algorithmically combined with a value sent from the server to form the final decryption keys, a combination of these actions, or the like.

Moreover, the checking modification program may be downloaded to the STB periodically or just before, while content was being streamed, or any combination. This means that the particular version of the checking modification program might not even be resident in the STB when the software is compromised. In addition, the checking program may be delivered in a secure encrypted form. The checking program may also delete itself after an analysis is completed to make it even harder for a hacker to observe it. Moreover, even where the CMP may reside on the STB, or some other client device, it may be encrypted. However, where the CMP is unencrypted, it may not be helpful to a hacker, as the hacker may still not have access to initialization parameters associated with using the CMP.

Illustrative Environment

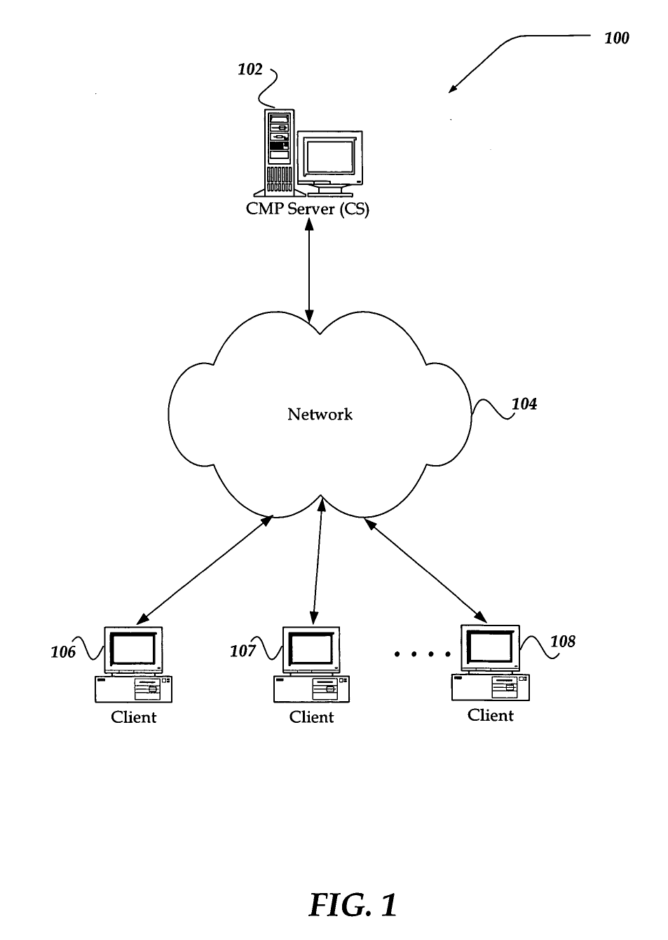

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes CMP server (CS) 102, network 104, and clients 106-108. Network 104 is in communication with CS 102 and clients 106-108.

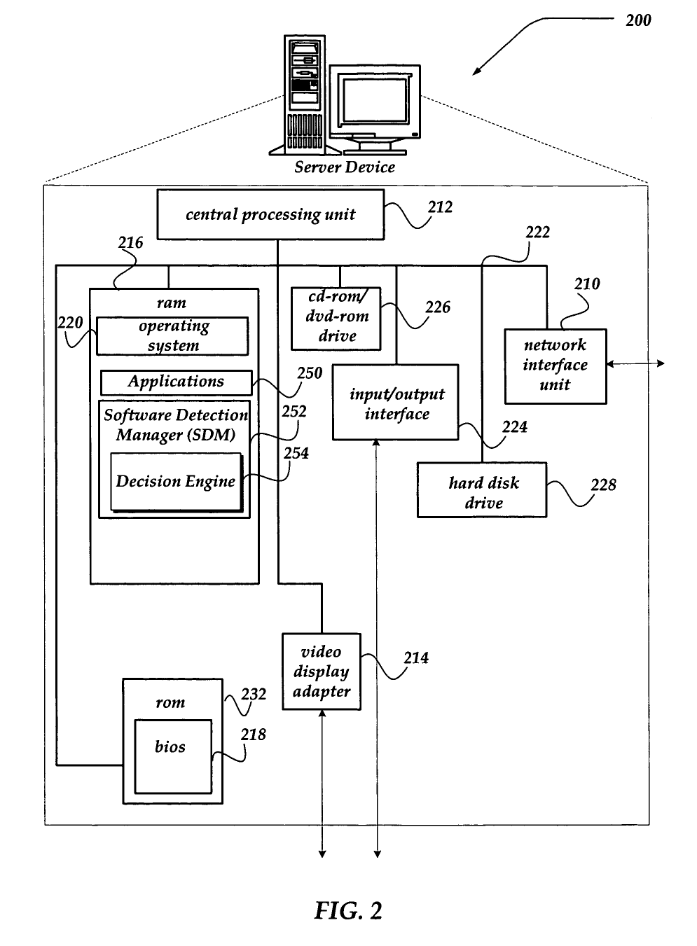

CS 102 is described in more detail below in conjunction with FIG. 2. Briefly, however, CS 102 includes virtually any network device that is configured to enable detection of a modification of software using the CMP. CS 102 may for example, determine a pattern based on selected software to be evaluated. Such selected software may be, for example, VSC software. However, the invention is not so constrained, and virtually any software may be evaluated. In one embodiment, the software to be evaluated is downloaded onto a client device, such as client devices 106-108.

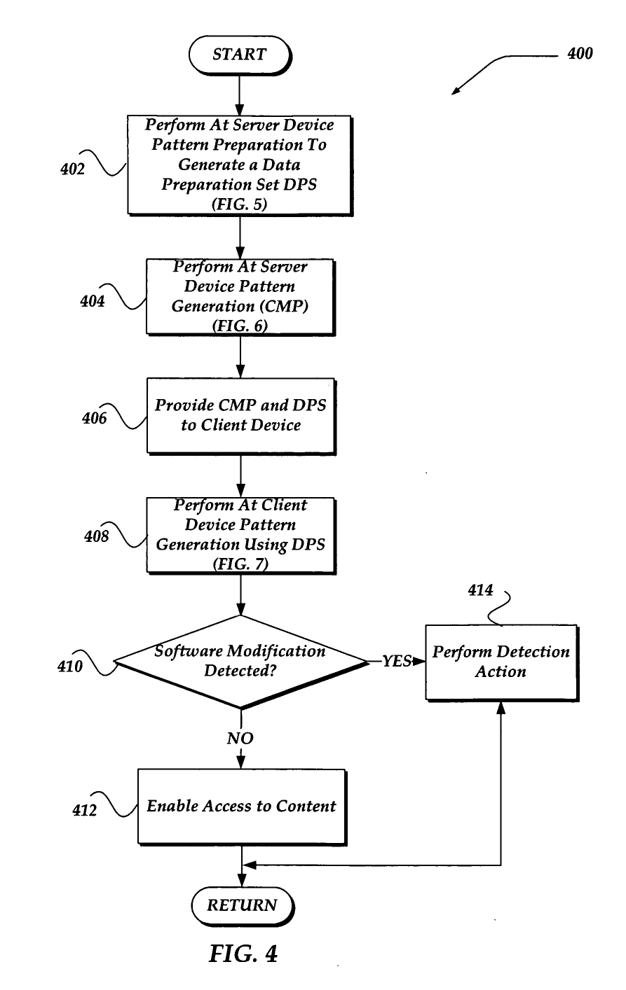

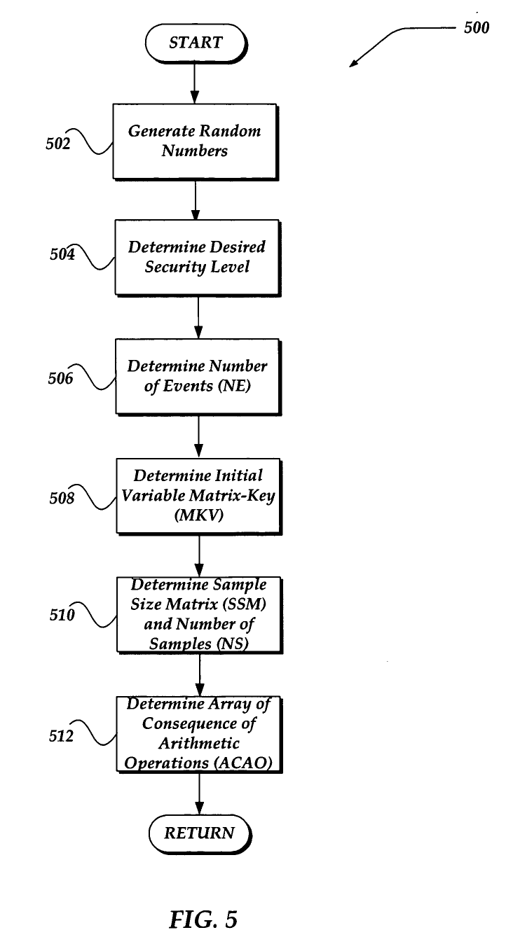

CS 102 may enable detection of a modification of software using a variety of mechanisms. For example, CS 102 may determine a desired pattern based on evaluating a known unmodified version of the software to be evaluated. CS 102 may then provide a copy of the CMP to a client device. The client device may then execute the CMP upon its copy of the software to be evaluated, using in part, parameters that may be provided by CS 102. The result of the client device performing the CMP includes a pattern that is based on the integrity of the evaluated software. Then, as described above, in one embodiment, the client device provides its pattern to CS 102, which may compare the pattern to a desired pattern (prototype pattern) to determine whether a modification of the client's copy of the software has occurred. In another embodiment, CS 102 may provide the desired pattern to the client device to enable the client device to make the comparison. In still another embodiment, CS 102 may employ the desired pattern to determine a decryption key. CS 102 may then send to the client device, a portion of the decryption key. The portion provided to the client device may then be algorithmically combined with the client's pattern to form the decryption key that may be employed to enable access to content, enable execution of software, or the like. CS 102 may employ a process such as described below in conjunction FIGS. 4-5 to perform at least some of the above actions.

CS 102 may also be configured to provide a copy of the software to be evaluated to a client device, such as client devices 106-108. As stated above, in one embodiment, the software represents, at least in part, VSC software. For example, CS 102 may determine that an update to the software is available. CS 102 may then enable access to the updated software to the client device.

CS 102 may further be configured to provide media content that may be distributed to client devices 106-108. Such content, includes, but is not limited to motion pictures, movies, videos, music, PPV, VoD, interactive media, audios, still images, text, graphics, and other forms of digital content directed towards a user of a client device, such as client devices 106-108. CS 102 may also include businesses, systems, and the like that obtain rights from a content owner to copy and distribute the content. CS 102 may obtain the rights to copy and distribute from one or more content owners. CS 102 may repackage, store, and schedule content for subsequent sale, distribution, and license to other content providers, users of client devices 106-108, and the like. In one embodiment, the content may be encrypted. In one embodiment, the content may be encrypted such that a decryption key based, at least in part, on the results of the CMP, is to be employed to decrypt the content.

The invention is not limited, however, to having CS 102 provide the software, and/or content to client devices 106-108. For example, another network device, or other communications mechanism (not shown), may be employed to provide the software and/or content to client devices 106-108, without departing from the scope or spirit of the invention.

Network 104 is configured to couple one computing device to another computing device to enable them to communicate. Network 104 is enabled to employ any form of computer readable media for communicating information from one electronic device to another. Also, network 104 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between client devices 106-108 and CS 102.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

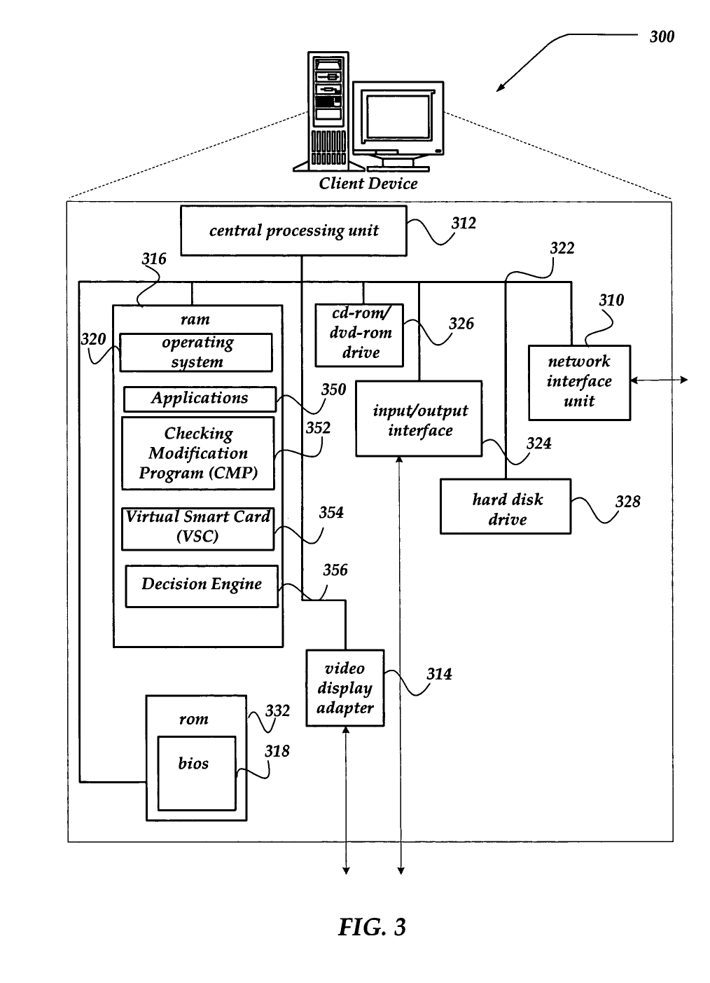

One embodiment of client devices 106-108 is described in more detail below in conjunction with FIG. 3. Briefly, however, client devices 106-108 may include virtually any computing device capable of receiving content and/or software over a network, such as network 104, from another computing device, such as CS 102. Client devices 106-108 may also include any computing device capable of receiving the content and/or software employing other mechanisms, including, but not limited to CDs, DVDs, tape, electronic memory devices, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Client devices 106-108 may also be any device that is capable of connecting using a wired or wireless communication medium such as a PDA, POCKET PC, wearable computer, media players, and any other device that is equipped to communicate over a wired and/or wireless communication medium to receive and play the content. Similarly, client devices 106-108 may employ any of a variety of devices to enjoy such content, including, but not limited to, a computer display system, an audio system, a jukebox, set top box (STB), a television, video display device, and the like.

Client devices 106-108 may further employ VSC software. Client devices 106-108 may employ the VSC software, for example, to manage access to content. The VSC software can be renewed over a network by downloading at least a portion of the VSC software (including new encryption/decryption keys), or by receiving it via another mechanism. Unique client-side VSC software may be generated for each STB using an STB's unique fingerprint. VSC software from one STB may be configured such that it can not be copied onto a different STB or made to work with another STB. This may be achieved by ‘tying’ the VSC software to each STB's unique fingerprint. The VSC software for each STB may be separately and uniquely generated during a provisioning process done in conjunction with a head-end server when the STB is first installed at a customer's site.

Unfortunately virtually all software systems including the VSC software may be vulnerable to software modification (alteration). These modifications could result in improper functioning of the VSC software and lead to unauthorized access to or copying of content. To fill this security hole, the present invention may be employed by combining VSC technology with the CMP technology and thereby generate a highly secure system.

Thus, client devices 106-108 may be configured to receive a checking program, such as the CMP, from CS 102 to determine whether software such as the VSC software has been modified. In one embodiment, client devices 106-108 may employ a process such as described below in conjunction with FIGS. 4, 6, and 7 to, in part, detect modification of software.

Illustrative Server Device

FIG. 2 shows one embodiment of a computing device, according to one embodiment of the invention. Server device 200 may include many more or less components than those shown. The components shown, however, are sufficient to disclose an illustrative embodiment for practicing the invention. Server device 200 may represent, for example, CS 102 of FIG. 1.

Server device 200 includes processing unit 212, a mass memory, and may include a video display adapter 214, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server device 200. Any general-purpose operating system may be employed. Basic input/output system (“BIOS”) 218 is also provided for controlling the low-level operation of server device 200. As illustrated in FIG. 2, server device 200 also can communicate with the Internet, or some other communications network, such as network 104 in FIG. 1, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Server device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server device 200 also may include input/output interface 224 for communicating with external devices, such as a mouse, keyboard, scanner, or other input devices not shown in FIG. 2. Likewise, server device 200 may further include additional mass storage facilities such as CD-ROM/DVD-ROM drive 226 and hard disk drive 228. Hard disk drive 228 may be utilized to store, among other things, application programs, databases, client device configuration information, policy, and the like.

The mass memory also stores program code and data. One or more applications 250 are loaded into mass memory and run on operating system 220. Examples of application programs may include, but is not limited to transcoders, HTTP programs, and so forth. Mass storage may further include applications such as software detection manager (SDM) 252.

SDM 252 is configured to enable detection of a modification of selected software. Such software may include binary code for a virtual smart card (VSC), for example. SDM 252 may periodically download to a client device a checking program, such as the CMP, for use in detecting software modifications. In one embodiment, SDM 252 may execute the CMP upon an unmodified copy of the software to obtain an initial set of parameters. The initial set of parameters may then be employed to vary operations of the CMP on the client device.

In one embodiment, SDM 252 includes decision engine 254 that is configured to receive results from the client device that are based on execution of the CMP on the client device. Decision engine 254 may then compare the received results against its results to determine whether the software on the client device is modified. If modification is detected, decision engine 254 may perform various actions, including, but not limited to, inhibiting sending of content to the client device, sending a message to a content owner regarding the modification, or a variety of other actions.

SDM 252 may also provide the client device with its results from the CMP such that the client device may perform the comparison between the results that the client device determines and the received results.

SDM 252 may also be configured, in another embodiment, to determine a value that is to be algorithmically combined with the results of the CMP on the client device to form a decryption key usable to decrypt received content. If the software on the client device is determined to be modified, the formed decryption key on the client device may be unable to decrypt the received content. Moreover, the client device may provide SDM 252, decision engine 254, or another device, a message indicating that modification of the software has been detected. SDM 252 may then perform a variety of actions, based, in part, on the message, including inhibiting sending of the content to the client device. SDM 252 may employ, at least in part, processes described below in conjunction with FIGS. 4-6 to perform at least some of its actions.

Selection of which of the above, or other, mechanism for detecting a modification may be based on a variety of criteria, or the like. For example, in one embodiment, where the server device and client device are employing a one-way communication mechanism such that the client device might not be able to send information to the server device, then detection of a modification may be determined at the client device. Where the client device and server device are employing a two-way communication mechanism, then any of the above mechanisms may be employed. However, it is noted that other criteria for selecting the mechanism for detection may be used, without departing from the scope or spirit of the invention.

Illustrative Client Device

FIG. 3 shows one embodiment of a computing device, according to one embodiment of the invention. Client device 300 may include many more components than those shown. The components shown, however, are sufficient to disclose an illustrative embodiment for practicing the invention. Client device 300 may represent, for example, client devices 106-108 of FIG. 1.

Client device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of client device 300. Any general-purpose operating system may be employed. Basic input/output system (“BIOS”) 318 is also provided for controlling the low-level operation of client device 300. As illustrated in FIG. 3, client device 300 also can communicate with the Internet, or some other communications network, such as network 104 in FIG. 1, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Client device 300 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Client device 300 may also includes input/output interface 324 for communicating with external devices, such as a hand-held remote control device, mouse, keyboard, scanner, or other input devices not shown in FIG. 3. Likewise, client device 300 may further include additional mass storage facilities such as CD-ROM/DVD-ROM drive 326 and hard disk drive 328. Hard disk drive 328 may be utilized to store, among other things, application programs, databases, client device configuration information, policy, and the like.

The mass memory also stores program code and data. One or more applications 350 are loaded into mass memory and run on operating system 320. Examples of application programs may include, but is not limited to transcoders, schedulers, calendars, database programs, word processing programs, HTTP programs, audio players, video players, VoD players, decoders, decrypters, PPV players, interface programs to an STB, interface programs to a television, video camera, and so forth. Mass storage may further include applications such as VSC 354, decision engine 356, and CMP 352, each of which may be downloaded from another computing device, such as CS 102 of FIG. 1.

VSC 354 includes computer-executable code static data, and the like, that is configured to enable content protection similar to physical smart card approaches. However, unlike the physical smart card approaches, VSC 354 is configured as software that may be downloaded to enable changes in security solutions to be implemented rapidly (in seconds, minutes, or hours) at relatively low costs. This is in stark contrast to physical smart card approaches that often require new hardware to be generated and distributed. Such physical approaches typically are made available as updates about once or twice a year.

Typical VSC 354 software may include various components (not shown) including, secure stores, fingerprinting modules, secure message managers, entitlement manages, key generators, digital copy protection engines, and the like. VSC 354, and its components, may be configured to enable protection of received content. In one embodiment, VSC 354 may be configured, in part, to employ the results of a checking modification program, such as CMP, to generate a decryption key for use in decrypting received content. In another embodiment, VSC 354 may receive the decryption key from another device, or component, such as CMP 352.

VSC 354 and its components may be represented by a sequence of binary data residing in mass memory. In one embodiment, the sequence of binary data representing VSC 354 includes the software to be evaluated. However, the invention is not so limited, and virtually any software may be evaluated.

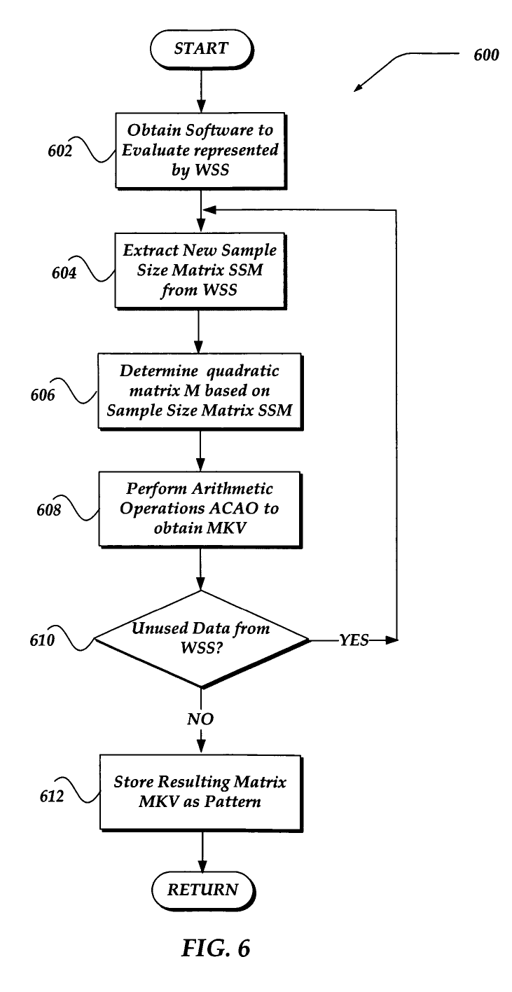

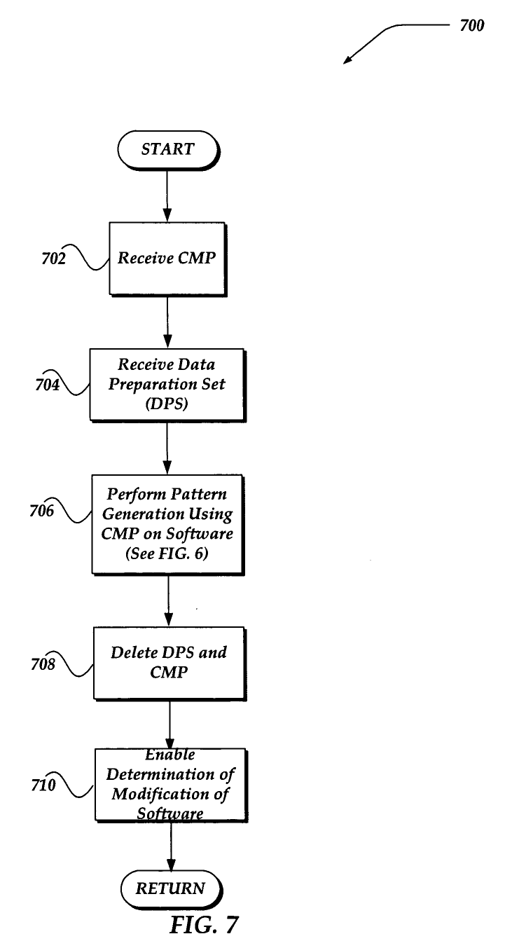

CMP 352 includes the checking program that may be downloaded from another computing device, such as CS 102 of FIG. 1, for use in generating a pattern that may be used in detecting a modification of the software being evaluated. CMP 352 may employ initial parameters, called a data preparation set (DPS), to perform such generation. Moreover, CMP 352 may receive various other parameters that may vary operations of CMP 352. CMP 352 may employ processes such as those described below in conjunction with FIGS. 6-7 to perform at least some of its actions.

Decision engine 356 may be an optional component that may operate to perform an analysis on the results of CMP 352. For example, decision engine 356 may receive in encrypted form, a prototype pattern from a server device that is generated based on execution of the CMP on a copy of the software that is assumed to be unmodified. The prototype pattern may then be decrypted for use by decision engine 356. Decision engine 356 may compare the prototype pattern with the pattern generated by CMP 352 to determine whether the software on client device 300 is modified. In one embodiment, decision engine 356 may also be employed to algorithmically combine the pattern from CMP 352 with another value to generate a decryption key for use in decrypting content by another program, such as VSC 354. Decision engine 356 may, but need not, be provided to client device 300, if it is desirable to have a server device to receive and perform the analysis on the results of CMP 352.

CMP Algorithm

One embodiment is next presented of an algorithm for use in detecting a modification of software. After presenting the algorithm, and mathematics underlying the algorithm, processes are present that illustrate one embodiment for using the algorithm in detecting the modification of the software.

It is noted that while, in one embodiment, the CMP as described below may be employed to generate a portion of a key for use in creating a decryption key, the invention is not so limited. Thus, for example, virtually any mechanism that is based on the integrity of the software being evaluated may be employed to generate the decryption key. For example, in one embodiment, the portion based on the integrity of the software might be based on various static determinations, including a checksum of at least a portion of the software, a redundancy check value, or similar integrity check values. In another embodiment, the portion based on the integrity may also be based on other static determinations, including, but not limited to, a run-length encoding check bit generation, an error correcting code (ECC) check bit generation, an XOR operation, shift and add, and/or other combinations of these and similarly generated set of values that may reliably indicate whether the software has been modified.

In one embodiment, the portion that is based on the integrity of the software may also be based on a dynamic determination. For example, in one embodiment, differing calculations may be performed on the same or different portions of the software and/or data that may be randomly selected and/or rotated over time, to increase a level of difficulty of detecting how the integrity value is determined. One such dynamic approach is described below, as the CMP.

The CMP presented below includes an effective methodology that allows transforming virtually any Boolean string (or text and/or digital string) of virtually any size to a relatively smaller matrix. The size of the created matrix-pattern can be as small as 2×2, or as large as desired. The client device runs the algorithm on memory locations that include the VSC, or other software, and generates a unique pattern. Optionally a server device may also run the same algorithm so it knows the values that the client is expected to generate.

An initial pattern is generated, called the “prototype,” and a subsequent pattern may be generated during runtime on the client device, called the “pattern.” In the comparison process the pattern and prototype are matrices and are therefore compared using matrix operations. If a result of the comparison is acceptable, the CMP may be configured to enable the server device to send the content to the client along with any decryption keys needed for decryption of the content. The VSC software may be kept in encrypted form until a message is received that indicates that the pattern has been calculated and is ready for comparison. The prototype may appear in decrypted form for a very short period of time.

Furthermore, the pattern and prototype may be dynamic (virtual) matrices. The pattern creation process combines binary data obtained from the VSC software with the DPS of initialization parameters that are created on the server. The DPS set of initialization parameters may be used as virtual keys that influence an outcome of the results. In one embodiment, the virtual keys may be unique from session to session and have a low probability of being reproduced exactly.

The DPS set of initialization parameters may be created using a variety of mechanisms. For example, in one embodiment, the DPS set of initialization parameters may be created using a random number generator, pseudo-random number generator, or the like.

A size of the pattern and prototype matrices may depend on how they are created and also on a desired level of security, as described in more detail below. The level of security may be considered as a probability for getting the right pattern parameters by the hacker.

Transforming a Large Set of Binary Values into a Small Matrix

Let's assume that 0 or 1 in the executable VSC file representing the consequence of different events, such as 0 or 1, which can happen in our binary string. The certain number of these events can represent the vector as a pattern related to this part of string. The certain number of vector-patterns can represent a chosen sample size as pattern of patterns by matrix. The number of sample size patterns or matrices can represent the binary string that may be created by given VSC software. It is desired that vector size be equal to or more than the number of vectors in the matrix. In a first case, a quadratic matrix may be created by default. In a second case, by multiplying the matrix with a transposition of the same matrix, a quadratic symmetric matrix may also be obtained. In both cases, the size of the obtained matrices will be number of vectors*number of vectors. So, the consequence of quadratic matrices may be used of identical sizes instead of the binary file. Any mathematical operations may be performed, such as ‘+’, ‘−’, ‘/’, or ‘*’, between nearest two matrices from the obtained consequence, to determine a quadratic matrix as a final outcome. Thus, the whole binary file of the VSC software can be transformed to one quadratic matrix. This matrix may represent a unique compacted pattern of the real binary file.

Mathematical Descriptions of the Procedures Necessary for the Pattern Classification

Below are some abbreviations that are employed in describing the CMP algorithm:

0, 1—are Boolean elements that represent different events in a binary string;

NE—represents a Number of Events that includes a number of Boolean elements 0 or 1;

WSS—is a Whole Sample Space that represents a Number of all Boolean elements in the software's binary string that is to be evaluated. In one embodiment, WSS represents the VSC software that is to be evaluated. However, the invention is not so limited, and WSS may also represent other binary strings within another software component, static data store, middleware, at least a portion of an operating system, or the like;

MK—is a Matrix-Key. In one embodiment, MK may be generated by a random number generator, pseudo-random number generator, or the like. In one embodiment, MK represents a matrix of size 3×3, 4×4, or 5×5;

SSM—is a Sample Size Matrix with size (II×NE), where II represents a number of rows and NE is representing the number of columns;

NS—is a Number of Samples SSM that includes in the whole sample space WSS;

ACAO—is an Array of Consequence of Arithmetic Operations. In one embodiment, ACAO may be selected randomly, however, the invention is not so limited, and ACAO may also be selected based on a variety of conditions, including a client device, or the like;

DPS—is a Data Preparation Set that serves as an Initiation Parameters to the CMP.

Let's assume that 0 or 1 in the VSC software represents the consequence of different events such as 0 or 1 that can happen in a binary string. The certain number of these events NE may then represent a vector such as a pattern related to a part of the string. The certain number of vector-patterns II can represent a chosen sample size as a pattern of patterns of matrix SSM. The number of sample size patterns or matrices SSM may further represent the binary string WSS that may be created by the VSC software.

It is noted that the VSC software, or other software of interest, may be configured as an executable binary file. Let's consider this binary file as a set of WSS Boolean elements that are arranged in as a special consequence. Each binary element represents one of the events 0 or 1. The set of WSS events may be parsed on the number of subsets NS maintaining a static length JJ, or dynamic lengths JJ(M), may be employed.

In the static length case, each subset may represent a part of the binary string with length JJ. JJ is fixed at a constant value for the runtime of the CMP. This value might be represented as a matrix by multiplying two static integer numbers such as JJ=II*NE, where NE>II, and II represents a number of rows in the matrix-subset, and NE represents a number of columns.

It is a non-issue, if the set of WSS events cannot be divided by the static length JJ=II*NE without a remaining fraction. This is because the number of events can be extended to the necessary JJ size by an addition of zeroes to the end of the string without loss of accuracy.

In the dynamic length case, each subset length is not fixed during the runtime of the CMP, and JJ(M) is represents a variable, where JJ(M)=II*NE(M), and II is a fixed value that represents a number of rows, and NE(M) is an array of different values calculated based on predetermined conditions, and M is a subset number. Such predetermined conditions might include an arithmetic progression, geometric progression, arrays, or other conditions that may produce a predictable result.

For simplicity, an example is described where length JJ is of a fixed value and a number of Boolean events NE=N is a single pattern. The number of events can be introduced as a vector-pattern Xᵢ in the N-dimensional Euclidean measurement space RN, where the parameter X_{i, k} k=1, N represents each component of the vector-pattern Xᵢ:
Xᵢ=(X_{i, 1}, X_{i, 2}, . . . , X_{i, k}, . . . , X_{i, N-1}, X_{i, N})
where X_{i, 1}, X_{i, 2}, . . . , X_{i, k}, . . . , X_{i, N-1}, X_{i, N} is a Boolean variable of 0 or 1.

Given II=M vectors—patterns X_{i, k}, which may characterize a chosen sample size, and where i=1, M, and in X_{i, k} k=1, N, they can be represented by the matrix A_{i,k} with a size (M*N) as follows:

$${A}_{i , k} = \vert \begin{matrix}{X}_{1 , 1} & {X}_{1 , 2} & … & {X}_{1 , k} & … & {X}_{1 , N - 1} & {X}_{1 , N} \\ {X}_{2 , 1} & {X}_{2 , 2} & … & {X}_{2 , k} & … & {X}_{2 , N - 1} & {X}_{2 , N} \\ {X}_{3 , 1} & {X}_{3 , 2} & … & {X}_{3 , k} & … & {X}_{3 , N - 1} & {X}_{3 , N} \\ … & … & … & … & … & … & … \\ {X}_{i - 1} & {Xi}_{, 2} & … & {X}_{i , k} & … & {X}_{i , N - 1} & {Xi}_{, N} \\ … & … & … & … & … & … & … \\ {X}_{M - 1 , 1} & {X}_{M - 1 , 2} & … & {X}_{M - 1 , K} & … & {X}_{M - 1 , N - 1} & {X}_{M - 1 , N} \\ {X}_{M , 1} & {X}_{M , 2} & … & {X}_{M - 1 , K} & … & {X}_{M , N - 1} & {X}_{M , N}\end{matrix} \vert$$

In the matrix A_{i,k} the number of rows i are equal to or less than the number of columns k, or N≧M. For preciseness, performance, and security reasons a diapason (interval) of the rows between 3 to 5, inclusive, and diapason of the columns from 3 to 14, inclusive, may be selected. However, the invention is not so constrained, and other values may be employed without departing from the scope or spirit of the invention. The number of columns may also be equal to or less than the number of rows. For simplicity of illustrations, discussions need not further describe this case as it is substantially the opposite of the case where N>M. To reduce the size of the matrix, and thereby reduce the amount of memory needed to store the matrix, the matrix A_{i,k} is transposed to the matrix A_{i,k}^{T} and perform matrix multiplication on A_{i,k} and A_{i,k}^{T} such as A_{i,k}*A_{i,k}^{T}. A new quadratic matrix A₁ may be obtained with a size M*M, which might be smaller than the initial matrices.

A next set of events can be introduced as a pattern by a vector Yᵢ in the same N-dimensional Euclidean measurement space R^{N}, where the parameter Y_{i, k} k=1, N represents a number of single Boolean patterns starting from the event numbered M*N+1 (or J+1) as components of the vector Yᵢ:
Yᵢ=(Y_{i, 1}, Y_{i, 2}, . . . , Y_{i, k}, . . . , Y_{i, N-1}, Y_{i, N})
where M vectors—patterns Yᵢ, i=1, M and in Y_{i, k} k=1, N then they can be represented by the matrix B_{i,k} with the size (M*N):

$${B}_{i , k} = \vert \begin{matrix}{Y}_{1 , 1} & {Y}_{1 , 2} & … & {Y}_{1 , k} & … & {Y}_{1 , N - 1} & {Y}_{1 , N} \\ {Y}_{2 , 1} & {Y}_{2 , 2} & … & {Y}_{2 , k} & … & {Y}_{2 , N - 1} & {Y}_{2 , N} \\ {Y}_{3 , 1} & {Y}_{3 , 2} & … & {Y}_{3 , k} & … & {Y}_{3 , N - 1} & {Y}_{3 , N} \\ … & … & … & … & … & … & … \\ {Y}_{i - 1} & {Yi}_{, 2} & … & {Y}_{i , k} & … & {Y}_{i , N - 1} & {Yi}_{, N} \\ … & … & … & … & … & … & … \\ {Y}_{M - 1 , 1} & {Y}_{M - 1 , 2} & … & {Y}_{M - 1 , K} & … & {Y}_{M - 1 , N - 1} & {Y}_{M - 1 , N} \\ {Y}_{M , 1} & {Y}_{M , 2} & … & {Y}_{M - 1 , K} & … & {Y}_{M , N - 1} & {Y}_{M , N}\end{matrix} \vert$$

In Matrix B_{i,k} (as well as is in the matrix A_{i,k}) the number of rows are selected to be equal to or lower than the number of columns, or N>M. The matrix B_{i,k} (as well as is in the matrix A_{i,k}) the diapason (interval) for the rows may be from 3 to 5, and diapason for the columns may be from 3 to 14. To again reduce the matrix size the matrix B_{i,k} may be transposed into matrix B_{i,k}^{T} by performing matrix multiplication on B_{i,k} and B_{i,k}^{T} such as B_{i,k}*B_{i,k}^{T}. As a result, a new quadratic matrix A₂ with the size M*M, is obtained which might be much smaller than the initial matrices.

Now consider two matrices A₁ and A₂ with the size of M*M. These are selected so that further calculations or comparisons between matrices A₁ and A₂ may be readily performed, as they have an equal number of rows and columns.

Continue performing the same on all the data and obtain a set A of matrices A_{L}, where L=1, NS. This set A represents the given Boolean events as a consequence of matrices-patterns A_{L}:
A=(A₁, A₂, . . . , A_{L}, . . . , A_{NS})

The consequence of NS matrices-patterns may be employed now rather than the given number of Boolean events. These matrices may be considered to represent a combination of the characteristics, quality, and consequences of the Boolean events. It may be inefficient to keep all these matrices in memory. Therefore, to minimize the information about these matrices that may be employed in the memory, the matrices may be combined to generate a single matrix by performing one of a variety of matrix operations, such as addition, subtraction, multiplication, or the like.

As an example, next is described how a single matrix may be generated employing subtraction matrix operations. Let's assume two new matrices A₁ and A₂ with size M*M:

$${A}_{1} = \vert \begin{matrix}{X}_{1 , 1} & {X}_{1 , 2} & … & {X}_{1 , M - 1} & {X}_{1 , M} \\ {X}_{2 , 1} & {X}_{2 , 2} & … & {X}_{2 , M - 1} & {X}_{2 , M} \\ … & … & … & … & … \\ … & … & … & … & … \\ {X}_{M - 1 , 1} & {X}_{M - 1 , 2} & … & {X}_{M - 1 , M - 1} & {X}_{M - 1 , M} \\ {X}_{M , 1} & {X}_{M , 2} & … & {X}_{M , M - 1} & {X}_{M , M}\end{matrix} \vert$$

$${A}_{2} = \vert \begin{matrix}{Y}_{1 , 1} & {Y}_{1 , 2} & … & {Y}_{1 , M - 1} & {Y}_{1 , M} \\ {Y}_{2 , 1} & {Y}_{2 , 2} & … & {Y}_{2 , M - 1} & {Y}_{2 , M} \\ … & … & … & … & … \\ … & … & … & … & … \\ {Y}_{M - 1 , 1} & {Y}_{M - 1 , 2} & … & {Y}_{M - 1 , M - 1} & {Y}_{M - 1 , M} \\ {Y}_{M , 1} & {Y}_{M , 2} & … & {Y}_{M , M - 1} & {Y}_{M , M}\end{matrix} \vert$$

Further, another matrix C₁, where C₁=A₂−A₁, may be determined, as:

$${C}_{1} = \vert \begin{matrix}{Z}_{1 , 1} & {Z}_{1 , 2} & … & {Z}_{1 , M - 1} & {Z}_{1 , M} \\ {Z}_{2 , 1} & {Z}_{2 , 2} & … & {Z}_{2 , M - 1} & {Z}_{2 , M} \\ … & … & … & … & … \\ … & … & … & … & … \\ {Z}_{M - 1 , 1} & {Z}_{M - 1 , 2} & … & {Z}_{M - 1 , M - 1} & {Z}_{M - 1 , M} \\ {Z}_{M , 1} & {Z}_{M , 2} & … & {Z}_{M , M - 1} & {Z}_{M , M}\end{matrix} \vert$$

where Z_{i,j}=Y_{i,j}−X_{i,j}; i=1, M; j=1, M. This completes Iteration 1 for calculating matrix C₁.

A new Iteration 2 may be completed after calculating matrix C₂ by subtracting C₁ from A₃, where A₃ is the sub pattern of a given Boolean file, which may be represented by vector A of matrices A₁, A₂, . . . , A_{L}, . . . , A_{IK} (1)
C2=A₃−C₁=A₃−(A₂−A₁)=A₃−A₂+A_{L}

Continuing in a similar manner Iteration 3, Iteration 4, and so on, up to Iteration K−1, may be performed, where a final result may be represented by matrix C_{K-1}.

Iteration 3:
C₃=A₄−C₂=A₄−(A₃−(A₂−A₁))=A₄−A₃+A₂−A₁

Iteration 4:
C₄=A₅−C₃=A₅−(A₄−(A₃−(A₂−A₁)))=A₅−A₄+A₃−A₂+A₁

Iteration L:
C_{L}=A_{L+1}−C_{L-1}=A_{L+1}−A_{L}+A_{L-1}− . . . +A_{I}−A_{I-1}+ . . . −A₂+A₁ (or +A₂−A₁).

And finally, Iteration NS−1:
C_{NS-1}=A_{NS}−C_{NS-2}=A_{NS}−A_{NS-1}+A_{NS-2}− . . . +A_{I}−A_{I-1}+ . . . −A₂+A₁ (or +A₂−A₁).

The symbols ‘+’ or ‘−’ (which represent the matrix operations of addition or subtraction, respectively) may depend on the situation where the number of Iterations or number of matrices involved in the calculation process, is odd or even. At any Iteration I, the matrix A_{I+1} may start with the symbol ‘+’ and may then be followed by subtraction and/or addition operations between matrices in a consequence.

Based on the previous explanation and by using Mathematical Induction methodology, the following results may be obtained for any Iteration number I, where I=1, K:

$${C}_{K - 1} = \{ \begin{matrix}{\sum }_{l = 1}^{K} ( - 1 ) ** I * AI , if {C}_{K - 1} ( mod 2 ) = 1 \\ {\sum }_{l = 1}^{K} ( - 1 ) ** ( I - 1 ) * AI , if {C}_{K - 1} ( mod 2 ) = 0.\end{matrix} \\ {C}_{K - 1} = \{ \begin{matrix}{\sum }_{l = 1}^{K} AI - 2 * I ( mod 2 ) * {\sum }_{l = 1}^{K} AI , if {C}_{K - 1} ( mod 2 ) = 1 \\ {\sum }_{l = 1}^{K} AI - 2 * ( I - 1 ) ( mod 2 ) * {\sum }_{l = 1}^{K} AI , if {C}_{K - 1} ( mod 2 ) = 0.\end{matrix} \\ {C}_{K - 1} = \{ \begin{matrix}{\sum }_{l = 1}^{K} AI * ( 1 - 2 * I ( mod 2 ) ) , if {C}_{K - 1} ( mod 2 ) = 1 \\ {\sum }_{l = 1}^{K} AI * ( 1 - 2 * ( I - 1 ) ( mod 2 ) ) , if {C}_{K - 1} ( mod 2 ) = 0.\end{matrix}$$

Thus, quadratic matrix CK−1 might contain size 3*3, 4*4, or 5*5 elements. This resulting matrix represents a compact pattern that may be generated from the contents of memory that the VSC software, or other software to be evaluated, is located.

Determination of a Desired Security Level

As described above, a given VSC Boolean file, or other software file or files, may be represented by a vector A of matrices A₁, A₂, . . . , A_{L}, . . . , A_{NS}. To make the output more robust and secure, different combinations may be used between several virtual initiation parameters such as a pattern size static (PSS), a pattern size dynamic (PSD), a number of patterns (NS), a matrix-key (MK), a key-array (ACAO) of mathematic operations between matrices, and various back and force calculation directions, or the like. From the initial parameters PSS/PSD and NS may be selected to be present in any possible combination. However, others may be employed without departing from the scope of the invention. In one embodiment, a combination like:
PSS∪NS∪MK (1)
may be employed. In another embodiment, a combination such as below may be used:
PSS∪NS∪MK∪ACAO. (2)

However, PSS/PSD and NS may be employed in any of the scenarios.

Preliminary determinations of the level of security can be achieved by determining a probability of any particular value appearing for each of the initial parameters. If a probability for each of initial parameters is available, the security level may be obtained. Thus, the final probability for any combination of virtual initial parameters can be determined as a multiplication of probabilities for each used parameter. For instance, based on the scenario (1), above:
P=P1*P2*P3
where P is a total probability, and P1, P2, and P3 are separate probabilities for the PSS/PSD, NS, and MK, respectively.

Separate probabilities may be determined for each of the virtual initial parameters, such as PSS and NS. Virtually any of 12 (from 3 to 14) variables may be selected to represent the pattern size and any of three variables (3, 4, and 5) may be selected to represent the number of patterns employed to create the matrices. From this example, 3*12=36 different final outcomes may be expected with a probability P:

P= 1/36 or 0.02(7)

With this, a hacker or other mechanism for modifying the software keeping in memory 36 possible outcomes, might have a 0.02(7) of probability to get a right result. To further increase the robustness of the CMP, the following may be employed based on creation of virtual initiation parameters, such as mentioned above. For example, in one embodiment, the initial matrix MK size 3*3, or 4*4, or 5*5 (depending on the variables 3, 4, or 5 representing the number of vector-patterns II) may be created using random numbers, pseudo-random numbers, or the like, from 1 to 10 for each raw matrix. The probability PR (II), (II=3, 5) of these events for each raw is:

PR (3)=10⁻³ for matrix of size 3*3,

PR (4)=10⁻⁴ for matrix of size 4*4,

PR (5)=10⁻⁵ for matrix of size 5*5.

Thus the probability for all events happening simultaneously for each matrix-key MK may be determined as:

PR (3)=10⁻⁹ for matrix of size 3*3

PR (4)=10⁻¹⁶ for matrix of size 4*4

PR (5)=10⁻²⁵ for matrix of size 5*5

Total probability for a hacker or other mechanism to obtain a real outcome matrix for scenario (1) may then:

PR=2.7(7)*10⁻¹¹ for matrix of size 3*3

PR=2.7(7)*10⁻¹⁸ for matrix of size 4*4

PR=2.7(7)*10⁻²⁷ for matrix of size 5*5

The results indicate the difficulty for hacker to determine a right outcome for the matrix elements given these probabilities. In addition, a hacker will need to determine the matrix MK, and what mathematical operation such as ‘+’, ‘−’, or ‘*’ will be used between matrix MK and the chosen matrix or matrices. The consequence of NS−1 mathematical operations may be obtained from the array ACAO, where any of operation may be chosen randomly, and implemented between NS matrices: +, +, −, *, *, −, +, *, . . . , −.

The probability to get a right operation symbol in the consequences is equal to about 3**NS−1), or if NS−1=35, a probability of:
P=1/((2.7(7)*10**2)*(3**35))

The above illustrates only a couple of examples of security levels that may be employed, however, the invention is not so limited, and others may be used, to vary the sizes of the matrices, and/or operations used.

Illustrative Operations for Detecting a Software Modification

The operations of certain aspects of the invention will now be described with respect to FIGS. 4-8. The processes described herein may be performed in a variety of ways. Thus, FIG. 4 illustrates a logical flow diagram generally showing one embodiment of an overview process for detecting unauthorized modifications of software using a checking modification program (CMP).

Process 400 of FIG. 4 begins, after a start block, at block 402, which is described in more detail below, in conjunction with FIG. 5. Briefly, however, at block 402 a pattern preparation is performed, typically at a server, to generate a Data Preparation Set (DPS), as described above. Processing then continues to block 404, which is described in more detail below in conjunction with FIG. 6. Briefly, however, at block 404, a pattern may be generated using the DPS from block 404, and the CMP. In one embodiment, this pattern, known as the prototype pattern, may be used to evaluate a resulting pattern provided by the client device. In another embodiment, the prototype pattern may be used, in part, to generate an encryption key for use in encrypting/decrypting content. In one embodiment, the prototype pattern may be algorithmically combined with another value to form the encryption/decryption key. In one embodiment, the other value may be provided to the client device in encrypted form, such that the client device must further employ another decryption key to access the other value. Then, after the client device employs the CMP, with the provided DPS, the client device combines its results with the other value to generate the decryption key. As described above, if modification of the software is not detected, then the decryption key may be used to decrypt the content. Moreover, the decryption key is properly formed through a correct application of the algorithmic combination of the values at the client device. Should the values be improperly combined, say by using an incorrect algorithmic combination, or a pattern that indicates tampering, then the generated decryption key may not be able to decrypt the content.

In one embodiment, the algorithmic combination of the values may be performed using a component of the client device, such that an STB, or similar client component, is unaware of the constituent components, including the pattern. This is directed at making it even more difficult to hack the decryption key.

In yet another embodiment, the prototype may be provided to the client device, for the client device to perform a comparison of its resulting pattern with the prototype.

In any event, upon determination of the prototype, and appropriate other actions, processing flows to block 406, where the DPS, CMP, and optionally the prototype are sent to a client device. In one embodiment, the DPS, CMP, and/or the prototype are encrypted using another encryption key, such as from a public/private key pair associated with the client device, server, or the like.

Process 400 flows next to block 408, which is described in more details below in conjunction with FIG. 7. Briefly, however, at block 408, the client device employs the DPS and CMP to generate its pattern that is based on the integrity of the evaluated software.

Processing then flows to decision block 410, where a determination is made whether a modification is detected to the software being evaluated. This determination, as described above, may be performed using any of the client-side determination, the server-side determination, key generation approach, or the like. It should be clear that these determinations are not mutually exclusive. Thus, one or more of these approaches may be combined, without departing from the scope or spirit of the inventions. Selection of which mechanism to employ to detect a modification may be based on a variety of criteria, including whether the client device and server device are in a one-way communication, two-way communication, a security issue, or the like.

In any event, if modification is detected, processing flows to block 414, where a detection action may be performed. Such detection actions, may include, but are not limited to, inhibiting access to the content by such as stopping the flow of the content to the client device, sending an message to a content owner, or the like. Processing then returns to a calling process, to perform other actions.

Alternatively, if modification to the software is undetected, access to the content may be enabled. Such enablement may arise by using the pattern to enable, in part, the decryption of the content, as described above; enabling a flow of the content to the client device; or a combination of actions. Processing then returns to a calling process, to perform other actions.

FIG. 5 illustrates a logical flow diagram generally showing one embodiment of a process for preparing for a pattern creation by generating a Data Preparation Set (DPS). In one embodiment, process 500 of FIG. 5 is performed at a server device, such as CS 102 of FIG. 1.

Process 500 begins, after a start block, at block 502, where a random number generator, pseudo-random number generator, or similar number generator, is employed to generate a sequence of numbers that are within a range of 1 to 10. The range of numbers, however, is not constrained to 1-10, and another range may be selected without departing from the invention. Processing then flows to block 504, where a desired security level is determined, using, in one embodiment, such guidance as provided above.

Processing flows next to block 506, where the results of block 502 are employed to generate a number of events NE that, in one embodiment, is from 3 to 14, inclusive. Processing continues next to block 508, where the results of block 502 may be employed to generate an initial matrix-key MK. In one embodiment, the results used at block 502 are a different portion of the sequence of numbers generated then employed in block 504. In one embodiment, MK is generated of size II*II, where II may be 3, 4, or 5, and II≦NE. However, II is not limited to these values and others may be used. MKV an initial variable MK is then set to MK.

Processing continues to block 510, where the sample size matrix SSM, and number of samples NS are determined. In one embodiment, SSM may be determined as NE*NE if NE=11, or as II*NE, if NE>II. In one embodiment, NS may include WSS, by setting NS=WSS/SSM. In one embodiment, if NS is a non-integer, then NS may be set to NS+1. However, the invention is not limited to these values, and others may be selected.

Process 500 flows next to block 512, where a random set of operations may be generated, such as ‘+,’ ‘−,’ ‘*,’ or the like. The sequence of random operations may be employed to create the array ACAO(K) of consequence of arithmetic operations for the space NS. Upon completion of block 512, MK, ACAO(K), NE, II, and NS may be used as the DPS. Process 500 then returns to a calling process to perform other actions.

FIG. 6 illustrates a logical flow diagram generally showing one embodiment of a process for performing the CMP to generate a pattern based on the software to be evaluated. In one embodiment, the software to be evaluated is the VSC software. Process 600 of FIG. 6 may be performed to generate the prototype pattern by a server device. Process 600 may also be employed by a client device to generate its pattern from the software to be evaluated.

In any event, process 600 begins, after a start block, at block 602, where the software to be evaluated is obtained and is further represented by the whole sample space WSS.

Processing flows next to block 604 where a new SSM is determined based on a number of events NE within WSS. That is, in a first loop through block 604, a first SSM may be obtained from WSS, with a subsequent Kth loop through block 604 obtaining the Kth SSM.

Processing continues next to block 606, where a quadratic symmetric matrix MK is determined. In one embodiment, if NE is greater than II, the transposition of SSM is obtained. SSM*SSMT is then determined to obtained MK, with a size of II*II. However, if NE is equal to II, then the resulting MK may be of size NE*NE. In any event, processing flows next to block 608.

At block 608, arithmetic operations from ACAO(K), are performed upon MKV and MK to determine a new value for MKV, as described above.

Processing then proceeds to decision block 610, where a determination is made whether there are more unused data within WSS to be employed. That is, has process 600 looped through the above steps NS times? If so, then processing flows to block 612; otherwise, processing loops back to block 604 to continue determining a new MKV, until the number of samples NS have been employed. At block 612, the resulting MKV is stored as the resulting pattern based on the samples from the software being evaluated. Processing then returns to a calling process to perform other actions.

FIG. 7 illustrates a logical flow diagram generally showing one embodiment of a process for a pattern creation to determine a modification of the software being evaluated. In one embodiment, process 700 of FIG. 7 may be implemented within client devices 106-108 of FIG. 1. Moreover, the software being evaluated may be such as the VSC, or the like. In any event, it is expected that the software being evaluated by process 700 is virtually the same software (unmodified) as that evaluated by the server device.

Process 700 begins, after a start block, at block 702, where the CMP may be provided to the client device. In one embodiment, the CMP is downloaded from a server device, such as CS 102 of FIG. 1. In one embodiment, the CMP may be encrypted, using a shared private key that is shared between the server device and the client device. In another embodiment, the CMP may be encrypted using a public/private key pair that enables only the receiving client device to decrypt the CMP. In any event, upon decryption of the CMP, processing flows to block 704 where the DPS created by, such as process 500 of FIG. 1 is provided. In one embodiment, the DPS is also encrypted. In another embodiment, the DPS is provided in a same encryption package as the CMP. In which case, decryption of the DPS and CMP may be performed together. In any event, upon receipt, and optionally decryption of the DPS and/or CMP, processing flows to block 706.

At block 706, the CMP, and DPS are employed to determine a pattern for the software being evaluated. In one embodiment, block 706 may be performed using process 600 of FIG. 6. Upon the completion of block 706, a variable matrix MKV is available that may be used as the resulting pattern.

Processing continues next to block 708, where the DPS and CMP are deleted, or otherwise purged from the client device. This may be performed to make it more difficult for a hacker to reproduce the resulting pattern. Processing then flows to block 710, where the resulting pattern may then be used to enable the determination of a modification of the software being evaluated. As described in process 400, this may mean that the resulting pattern is sent to a server device for evaluation, the prototype pattern is received from the server device and decrypted for comparison with the resulting pattern, or the resulting pattern is combined with another value to be employed as a decryption key for content. In any event, process 700 returns to a calling process to perform other actions.

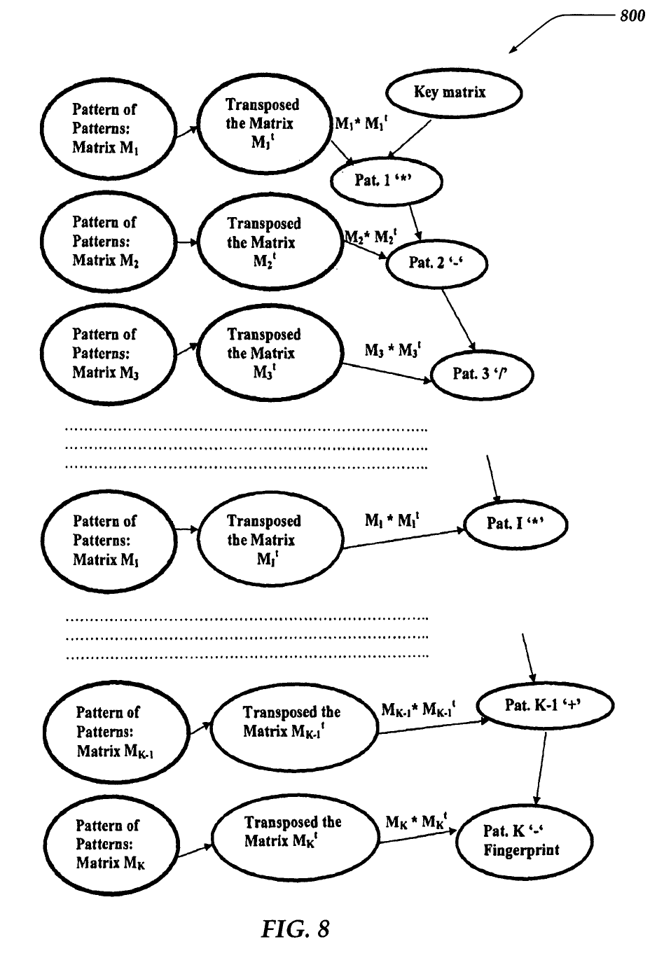

FIG. 8 illustrates a logical flow diagram generally showing one embodiment of a process generating a pattern usable in the CMP, in accordance with the invention. Process 800 may be employed to generate the pattern (or fingerprint), of the software being evaluated. As shown process 800 illustrates how various arithmetic operations may be performed upon matrices to generate the pattern, as described in more detail above.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A computer-readable medium having computer-executable instructions for detecting modification of a software component, the computer-executable instructions enabling actions comprising:
receiving first portion of a decryption key;
determining an integrity value associated with the software component;
combining the first portion of the decryption key with the integrity value to generate the decryption key;
employing the generated decryption key to attempt to decrypt content; and
if the integrity value indicates that the software component is unmodified and the generated decryption key is properly generated, successfully decrypting the content.

2. The computer-readable medium of claim 1, wherein the first portion of the decryption key is encrypted.

3. The computer-readable medium of claim 1, wherein determining the integrity value associated with the software component further comprises determining a checksum associated with at least a portion of the software component.

4. The computer-readable medium of claim 1, wherein determining the integrity value associated with the software component further comprises determining a value based on a sequence of mathematical operations using at least a portion of the software component.

5. The computer-readable medium of claim 1, wherein determining the integrity value associated with the software component further comprises:
determining a key matrix based, in part, on a desired security level;
parsing the software component into sample size matrices (SSM);
multiplying each SSM with its matrix transform (SSMT) to generate a quadratic symmetric matrix (M) for each SSM;
performing at least one arithmetic matrix operation between each quadratic symmetric matrix and the key matrix to generate another key matrix; and
employing the other key matrix as the integrity value for the software component.

6. The computer-readable medium of claim 5, wherein the at least one arithmetic matrix operation is randomly determined from at least one of a matrix addition, subtraction, or multiplication.

7. The computer-readable medium of claim 5, wherein determining the key matrix further comprises determining the key matrix's elements based, in part, on a number generator, and wherein a size of the key matrix is based on a desired probability of detecting a pattern.

8. The computer-readable medium of claim 5, wherein parsing the software component into sample size matrices (SSM) further comprises parsing the software component into a number of subset matrices of at least one of a static length or a dynamic length.

9. A method of detecting a modification of a software component, the method comprising:
determining a data preparation set of parameters (DPS) based, in part, on a desired security level, wherein the DPS includes a key matrix;
performing, at a server device, an integrity determination upon the software component residing on the server using the DPS to generate a prototype pattern;
providing the DPS to a client device;
performing, at the client device, the integrity determination upon a copy the software component residing on the client device using the DPS to generate a pattern;
comparing the prototype pattern to the pattern to determine whether a modification of the copy of the software component is detected, and
if a modification of the copy of the software component is detected, performing a detection action.

10. The method of claim 9, wherein comparing the prototype pattern to the pattern further comprises sending the pattern to the server device, wherein the server device performs the comparison.

11. The method of claim 9, wherein comparing the prototype pattern to the pattern further comprises sending the prototype pattern to the client device, wherein the client device performs the comparison.

12. The method of claim 9, wherein the integrity determination further comprises:
extracting from the software component a sample size matrix;
determining a quadratic matrix by multiplying the sample size matrix with a transpose of the sample size matrix;
performing a random selection of arithmetic matrix operations between the quadratic matrix and the key matrix, the result being one of the prototype pattern or the pattern.

13. A system of detecting a modification of a software component, comprising:
a server device, that is configured to perform actions, comprising:
determining a data preparation set of parameters (DPS), wherein the DPS is, at least in part, randomly selected, and is further determined based, in part, on a desired security level, the DPS including a key matrix;
determining a prototype pattern based on the DPS for a copy of the software component, wherein the determination comprises performing a randomly selected matrix operation on at least a portion of the copy of the software component; and
sending at least the DPS to a client device; and
the client device, that is in communication with the server device, and is configured to perform actions, comprising:
receiving at least the DPS; and
determining a pattern based on the received DPS for the software component, wherein the determination comprises performing the randomly selected matrix operation on at least a portion of the software component.

14. The system of claim 13, wherein the DPS further comprises a sequence of arithmetic matrix operations to be performed on at least a portion of the software component or copy of the software component.

15. The system of claim 13, further comprising:
a decision engine that is configured to perform actions, comprising:
receiving the prototype pattern;
receiving the pattern;
comparing the prototype pattern with the pattern to determine if the software component of the client device is modified; and
if a modification is detected, performing a detection action.

16. The system of claim 15, wherein the decision engine is configured to perform further actions, comprising:
algorithmically combining the pattern with another value to generate a decryption key that is based on an integrity of the software component on the client device.

17. The system of claim 15, wherein the decision engine resides within at least one of the server device or the client device.

18. A server device having computer-executable components for use in detecting a modification of a software component, the components comprising:
a transceiver for receiving and sending information;
a processor, in communication with the transceiver, that includes machine instructions that cause the processor to perform operations, including:
determining a data preparation set of parameters (DPS), wherein the DPS is based, at least in part, on a desired security level, the DPS including a key matrix;
determining a prototype pattern based on the DPS for a copy of the software component, wherein the determination comprises performing at least one matrix operation on at least a portion of the copy of the software component;
sending at least the DPS to a client device;
receiving a pattern for the software component, the pattern being determined in part on the received DPS, wherein the determination comprises performing the at least one matrix operation on at least a portion of the software component;
comparing the prototype pattern with the pattern to determine if the software component of the client device is modified; and
if a modification is detected, performing a detection action.

19. A client device for use in detecting a modification of a software component, the client device comprising:
a transceiver for receiving and sending information;
a processor, in communication with the transceiver, that includes machine instructions that cause the processor to perform operations, including:
receiving first value from a server;
determining an integrity value associated with at least a portion of the software component;
combining the first value with the integrity value to generate the decryption key; and
if the integrity value indicates that the software component is unmodified, enabling the decryption key to decrypt content.

20. The client device of claim 19, wherein determining the integrity value associated with the software component further comprises determining a checksum associated with at least the portion of the software component.

21. The client device of claim 19, wherein determining the integrity value associated with the software component further comprises performing a sequence of mathematical operations upon at least the portion of the software component to determine the integrity value.

22. The client device of claim 19, wherein combining the first value with the integrity value further comprises performing at least one of an exclusive OR (XOR), a series of rotates on the first value or the integrity value, an add, or a subtraction.

23. The client device of claim 19, wherein determining the integrity value associated with the software component further comprises determining at least one of a run-length encoding check bit, or an error correcting code (ECC) check bit for at least the portion of the software component.

24. A client device having computer-executable components for use in detecting a modification of a software component, the components comprising:
a processor that includes machine instructions that causes the processor to perform operations, including:
receiving a data preparation set of parameters (DPS), wherein the DPS includes a key matrix;
receiving a first portion of a decryption key to a client device;
determining an integrity pattern for the software component based in part on the received DPS; and
generating the decryption key by algorithmically combining the pattern with the first portion of the decryption key, wherein the decryption key enables decryption of content if the software component is unmodified.

25. The client device of claim 24, wherein determining the integrity pattern further comprises performing randomly selected matrix operations on at least a portion of the software component to, in part, generate the integrity pattern.

26. A modulated data signal for use in detecting a modification of a software component, the modulated data signal comprising instructions that enable the computing device to perform the actions of:
sending to a client device a data preparation set of parameters (DPS) that includes at least a key matrix;
providing to the client device, a prototype pattern that is based on the DPS and a matrix operation on at least a portion of a copy of the software component, the prototype pattern indicating an integrity of the copy of the software component;
enabling, at the client device, a determination of a pattern for the software component, the pattern being based in part on the received DPS and the matrix operation on at least a portion of the software component, the pattern indicating an integrity of the software component;
enabling the client device to compare the prototype pattern with the pattern to determine if the software component of the client device is modified; and
if a modification is detected, enabling the client device to perform a detection action.

27. The modulated data signal of claim 26, wherein the matrix operation further comprises a random selected matrix operation from at least one of a matrix add, matrix subtract, and a matrix multiply operation.

28. A client device for use in detecting a modification of a software component, comprising:
means for receiving a first value associated with content;
means for determining an integrity value associated with the software component;
means for combining the first value with the integrity value to generate a decryption key; and
if the integrity value indicates that the software component is unmodified, means for decrypting content.
